(19) United States
(12) Patent Application Publication
(10) Pub. No.: US 2010/0108589 A1
(43) Pub. Date: May 6, 2010

(54) Single-Piece Tapped Plate and Retainer for Fluid Filters

(75) Inventors: Randy Charles FRYE, Lillington, NC (US); Ken MORTON, Fayetteville, NC (US); Sudheer GHADIYARAM, Fayetteville, NC (US)

Correspondence Address: CROWELL & MORING LLP;INTELLECTUAL PROPERTY GROUP, P.O. BOX 14300, WASHINGTON, DC, 20044-4300, US

(73) Assignee: PUROLATOR FILTERS NA LLC, Fayetteville, NC (US)

(21) Appl. No.: 12/263,720

(22) Filed: Nov. 3, 2008

(51) Int. Cl. B01D 35/30

(52) U.S. Cl. 210/232; 210/459

(57) ABSTRACT

The present invention relates generally to a fluid filter assemblies. In particular, the present invention is directed to fluid filter assemblies comprising a single-piece tapped plate and retainer.

### FIELD OF THE INVENTION

The present invention relates generally to a fluid filter assemblies.

### BACKGROUND OF THE INVENTION

Fluid filter assemblies are used to filter fluids. Fluids which may be filtered by fluid filter assemblies include, but are not limited to, oil, hydraulic fluid, and transmission fluid. Oil filters are commonly used in much of today's machinery, most notably in automobiles and other vehicles, but they are also essential components in all engines that rely on oil for engine lubrication for maintaining durability and performance. The present invention is related to a fluid filter having a filter element sealed inside a canister. These types of filters are commonly used in applications that require uninterrupted oil lubrication for moving parts, in which continually filtered oil is supplied through the fluid filter as part of a lubrication circuit. Conventional fluid filters, such as a typical spin-on or canister sealed fluid filters, include a set of components that are made both of metallic or non-metallic materials that support the main function of filtration performed by the filter element housed inside the can. A typical conventional fluid filter assembly includes a filtering element within a housing, and a two-piece tapped plate retainer assembly in which the tapped plate has a plurality of openings to enable fluid to flow in to and out of the filter assembly. Referring to FIG. 1, according to the conventional methods of construction, the following components are typically included in a convention fluid filter assembly:
Filter housing 12.
Tapped Plate with retainer 13.
Seal gasket 10.
Filter Media element 11 with supporting Center tube 09.
Anti Drain Back Valve (ADB) 16.
Relief valve 08.
Bottom support 19.

Conventional fluid filter assemblies require that the tapped plate and retainer be welded or clinched together, and often requiring a sealant between the taped plate and the retainer.

The current two-piece tapped plate and retainer assembly requires additional, expensive, manufacturing steps and results in a fluid filter assembly that may be prone to leaking between the tapped plate and the retainer.

### SUMMARY OF THE INVENTION

According to an aspect of the present disclosure there is provided a fluid filter assembly. The fluid filter assembly comprises a filtering element within a housing, and a single-piece tapped plate and retainer in which the tapped plate and retainer has a plurality of openings to enable fluid to flow in to and out of the filter assembly

The present invention further contemplates a single-piece tapped plate and retainer for use in a fluid filter assembly.

One embodiment of the present invention encompasses a fluid filter assembly comprising a housing, a filtering element; and a single-piece tapped plate and retainer.

Another embodiment of the present invention encompasses a fluid filter assembly comprising a single piece-tap plate and retainer having a threaded aperture.

### BRIEF DESCRIPTION OF THE DRAWINGS

FIG. 1 shows a diagram of a conventional spin-on oil filter;

FIG. 2 shows cross-sectional view of one embodiment of the instant invention.

FIGS. 3 shows one embodiment of the instant invention as part of a fluid filter assembly before seaming.

FIG. 4 shows one embodiment as part of a sealed fluid filter assembly.

FIG. 5 shows the seal between a single-piece tapped plate and retainer in accordance with the instant invention and a fluid filter housing.

FIG. 6 shows cross-sectional view of one embodiment of the instant invention

FIG. 7 shows one embodiment of the instant invention as part of a fluid filter assembly before seaming.

FIG. 8 shows one embodiment as part of a sealed fluid filter assembly.

FIG. 9 shows the seal between a single-piece tapped plate and retainer in accordance with the instant invention and a fluid filter housing.

FIG. 10 shows cross-sectional view of one embodiment of the instant invention

FIG. 11 shows one embodiment of the instant invention as part of a fluid filter assembly before seaming.

FIG. 12 shows one embodiment as part of a sealed fluid filter assembly.

FIG. 13 shows the seal between a single-piece tapped plate and retainer in accordance with the instant invention and a fluid filter housing.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement of steps disclosed herein.

Referring to FIG. 1, according to the conventional methods of construction, the following components are typically included in a convention fluid filter assembly:
Filter housing 12.
Tapped Plate with retainer 13.
Seal gasket 10.
Filter Media element 11 with supporting Center tube 09.
Anti Drain Back Valve (ADB) 16.
Relief valve 08.
Bottom support 19.

The conventional two-piece tapped plate with retainer assembly requires addition manufacturing steps and results in a tapped plate and retainer assembly that may be prone to leaks. The present invention solves these issues with a single-piece tapped plate and retainer assembly. The tapped plate of the instant invention is constructed such that there is no need for a retainer or plate to retainer plate sealant.

The present invention is directed to a single-piece tapped plate and retainer for use in fluid filter assemblies. The present invention is particularly suited for use in spin-on type oil filters.

The single piece tapped plate and retainer of the present invention will significantly reduce the cost and construction of the case bottom assembly of fluid filter assemblies while simultaneously reducing the potential for leaks between the tapped plate and the retainer. The single piece tapped plate and retainer of the instant invention will also eliminate the need for a sealant between the tapped plate and the retainer. The single piece tapped plate and retainer of the instant invention also eliminates the need to clinch or weld the tapped plate to the retainer.

The single-piece tapped plate and retainer of the present invention may be made in accordance with any of the known methods of fabricating parts including, but not limited to, machining, molding, lathing, rolling, casting, welding, milling, or extrusion.

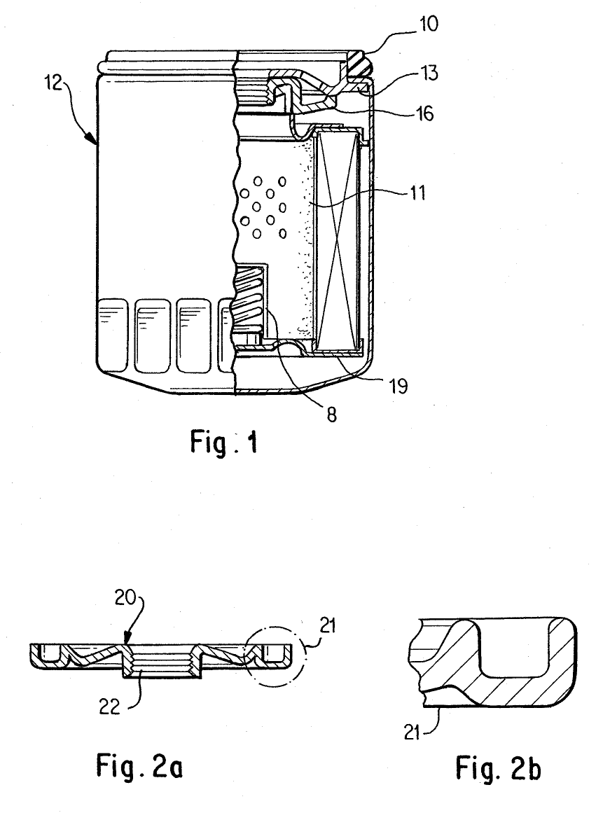

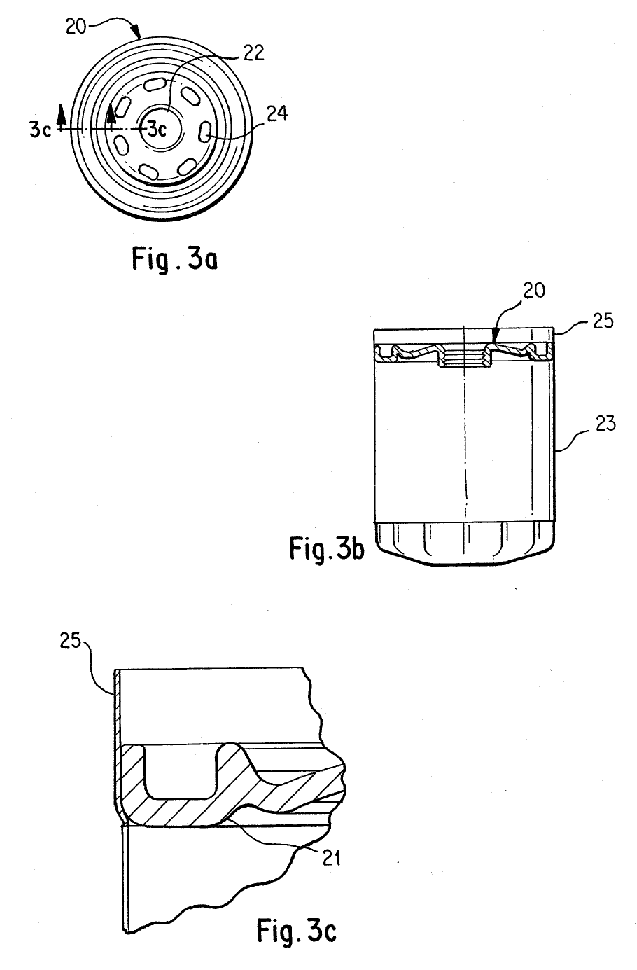

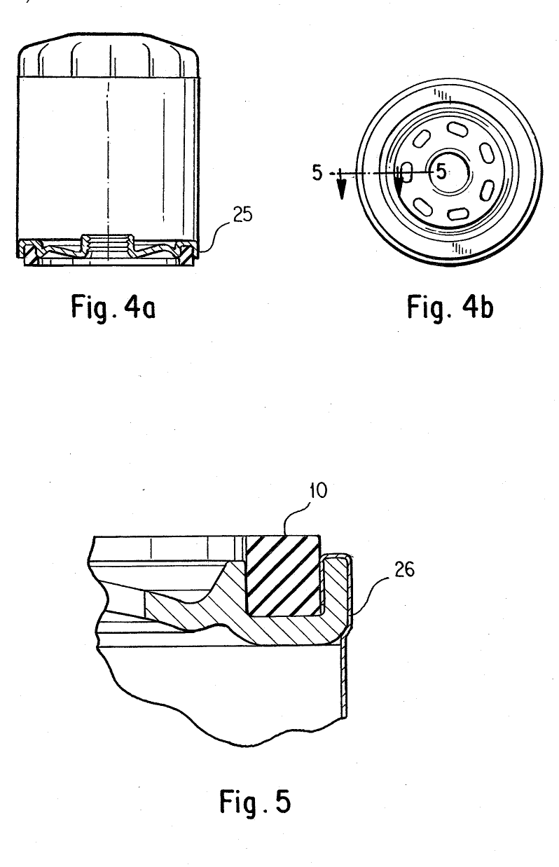

Referring now to FIG. 2, there is shown an embodiment of the instant invention in the form of cross sectional view of single-piece tapped plate and retainer 20, comprising edge 21, and threaded aperture 22. Enlarged view of edge 21 is further provided as part of FIG. 2. As can be seen in FIG. 3, single-piece tapped plate and retainer 20 is generally circular in nature having a concaved surface comprising multiple fluid inlet ports 24 as well as central threaded aperture 22. FIG. 3 provides a view of the interconnection between tapped plate and retainer 20 and housing 23 prior to seaming. Edge 21 of single-piece tapped plate 20 is in contact with housing edge 25. As seen in FIG. 4, housing edge 25 is then folded over edge 21 by mechanical means thereby forming fluid tight seal 26 between housing 23 and single-piece tapped plate and retainer 20. Referring to FIG. 5, seal gasket 10 is further provided to effect a fluid tight seal between the filter assembly and any motor to which it is attached.

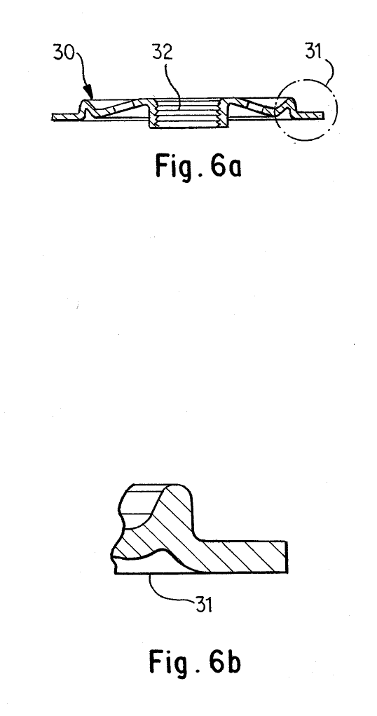

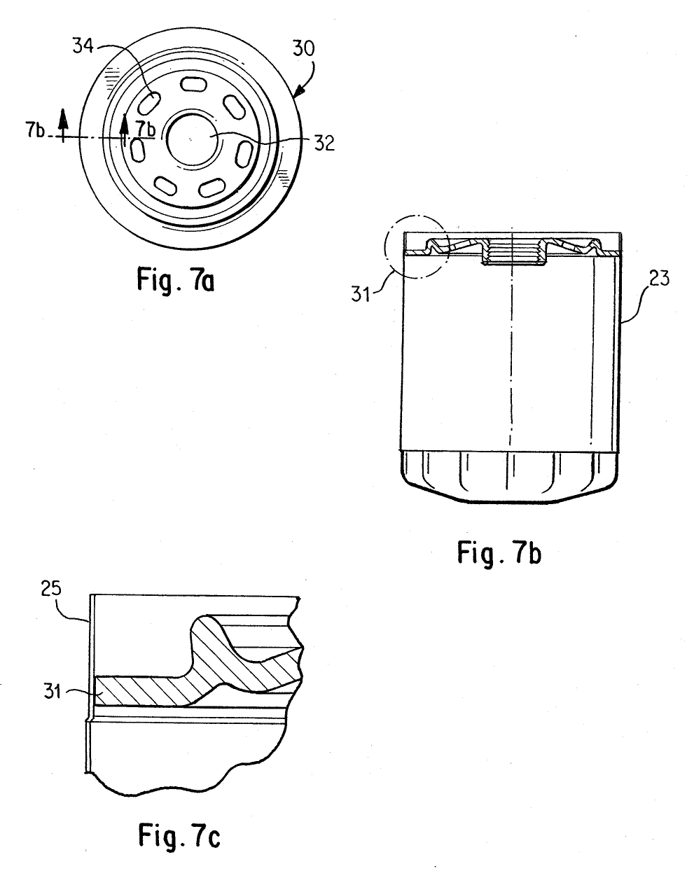

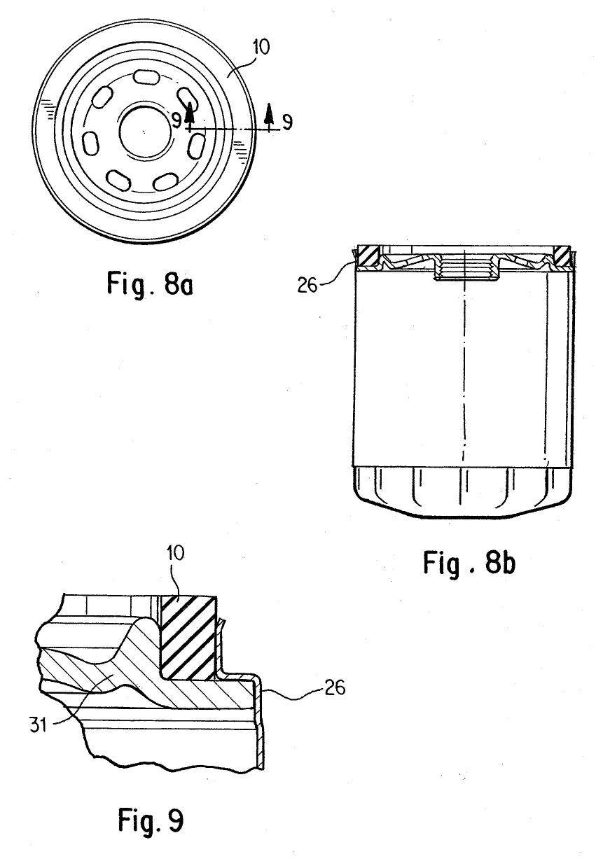

Referring now to FIG. 6, there is shown another embodiment of the instant invention in the form of cross sectional view of single-piece tapped plate and retainer 30, comprising edge 31, and threaded aperture 32. Enlarged view of edge 31 is further provided as part of FIG. 6. As can be seen in FIG. 7, single-piece tapped plate and retainer 30 is generally circular in nature having a concaved surface comprising multiple fluid inlet ports 34 as well as central threaded aperture 32. FIG. 7 provides a view of the interconnection between tapped plate and retainer 30 and housing 23 prior to seaming. Edge 31 of single-piece tapped plate 30 is in contact with housing edge 25. As seen in FIG. 7, housing edge 25 is then folded over edge 31 by mechanical means thereby forming fluid tight seal 26 between housing 23 and single-piece tapped plate and retainer 30. Referring to FIG. 9, seal gasket 10 is further provided to effect a fluid tight seal between the filter assembly and any motor to which it is attached.

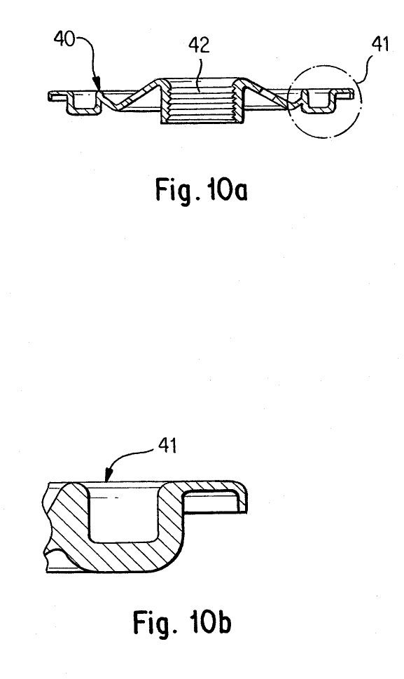

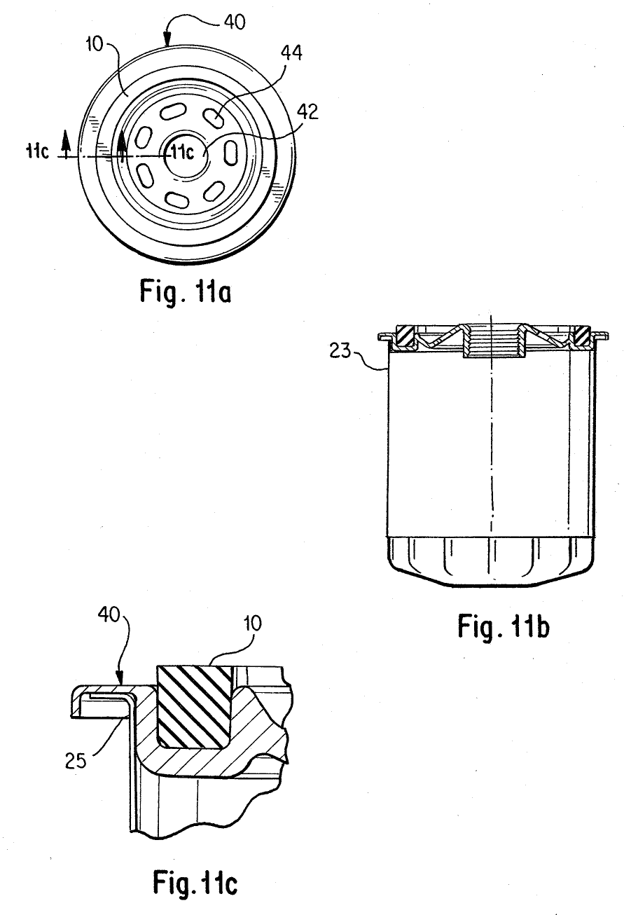

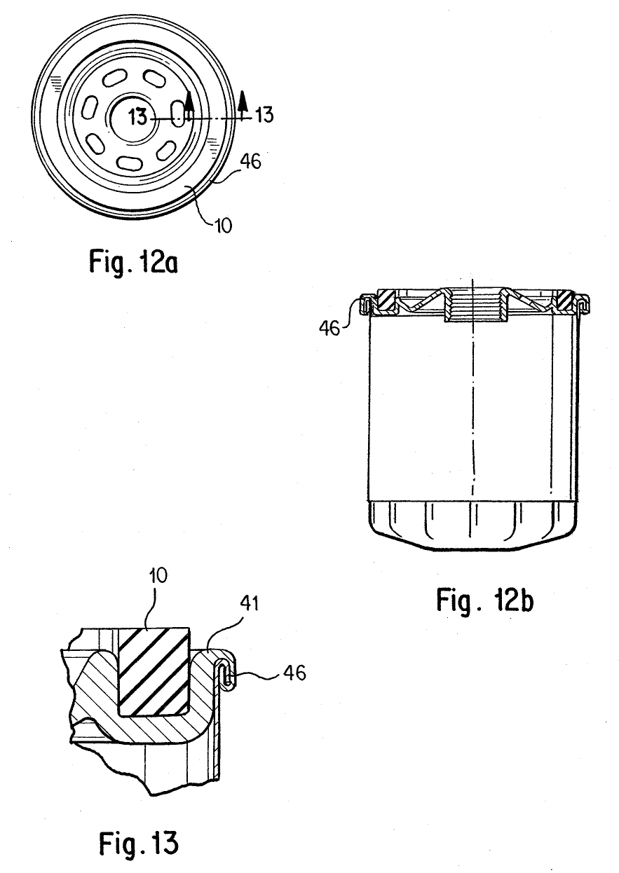

Referring now to FIG. 10, there is shown an embodiment of the instant invention in the form of cross sectional view of single-piece tapped plate and retainer 40, comprising edge 41, and threaded aperture 42. Enlarged view of edge 41 is further provided as part of FIG. 10. As can be seen in FIG. 11, single-piece tapped plate and retainer 40 is generally circular in nature having a concaved surface comprising multiple fluid inlet ports 44 as well as central threaded aperture 42. FIG. 11 provides a view of the interconnection between tapped plate and retainer 40 and housing 23 prior to seaming. Edge 41 of single-piece tapped plate 40 is in contact with housing edge 25. As seen in FIG. 12, housing edge 25 and tapped plate and retainer edge 41 are then folded over by mechanical means thereby forming an interlocking fluid tight seal 46 between housing 23 and single-piece tapped plate and retainer 40. Referring to FIG. 13, seal gasket 10 is further provided to effect a fluid tight seal between the filter assembly and any motor to which it is attached.

While the invention has been described with reference to certain exemplary embodiments thereof, those skilled in the art may make various modifications to the described embodiments of the invention without departing from the scope of the invention. The terms and descriptions used herein are set forth by way of illustration only and not meant as limitations. In particular, although the present invention has been described by way of examples, a variety of devices would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A fluid filter assembly, comprising:
a housing;
a filtering element; and
a single-piece tapped plate and retainer.

2. The fluid filter assembly according to claim 1, wherein the single-piece tapped plate and retainer further comprise a threaded aperture.

3. The fluid filter assembly according to claim 1, wherein the fluid filter assembly is a spin-on type.

4. The fluid filter assembly according to claim 1, further comprising a gasket seated on the single-piece tap plate and retainer.

5. The fluid filter assembly according to claim 2, wherein the single-piece tapped plate and retainer further comprises fluid inlet ports adjacent to the threaded aperture.

6. A single-piece tapped plate and retainer for use in a fluid filter assembly.

7. The single-piece tapped plate and retainer of claim 6, further comprising a threaded aperture.

8. The single-piece tapped plate and retainer of claim 7, further comprising fluid inlet ports adjacent to the threaded aperture.

9. A fluid filter assembly, comprising:
a housing;
a filtering element; and
a single-piece tapped plate and retainer.
